(19) United States
(12) Patent Application Publication
(10) Pub. No.: US 2012/0191624 A1
(43) Pub. Date: Jul. 26, 2012

(54) SYSTEM FOR PROVIDING MEDIA MANAGEMENT, CHAIN OF TITLE, AND DATA INTEGRITY

(76) Inventors: Greg S. Ousley, (US); Mark Parsells, (US); Bruce Gilmore, (US)

(21) Appl. No.: 13/356,273

(22) Filed: Jan. 23, 2012

Related U.S. Application Data
(60) Provisional application No. 61/435,034, filed on Jan. 21, 2011.

(51) Int. Cl. G06Q 10/00

(52) U.S. Cl. 705/342

(57) ABSTRACT

A method, system, and data structure that may provide increased certainty to the process of selling, transferring, or purchasing debt portfolios by providing chain of title verifications for debt accounts is provided herein.

### CROSS REFERENCE TO PRIOR APPLICATIONS

This application claims priority and the benefit thereof from U.S. Provisional Patent Application No. 61/435,034, filed on Jan. 21, 2011, titled “System For Providing Media Management, Chain of Title, and Data Integrity,” the entirety of which are hereby incorporated herein by reference.

### BACKGROUND OF THE PRESENT DISCLOSURE

1. Field of the Present Disclosure

The present disclosure provides a system for media management, chain of title, and data integrity that facilitates maintenance and management of debt ownership.

2. Related Art

In today's economic climate, issuer's of credit (hereinafter “Issuer”) and buyer's of debt (hereinafter “Debt Buyer”), who once functioned without a lot of scrutiny, now find themselves the subject of attention by the judiciary, government, and news media. The once predictable process of collecting charged off debt has now become less predictable, and sometimes uncertain, because existing rules, regulations, and statutes require issuers and Debt Buyers to prove ownership of accounts with greater documentation.

In uncertain economic times, trust may take the back seat to verification. Whether the context is a home purchase, business reorganization, or employment application, the parties typically require a demonstration of credit worthiness, financial status, job history, or education history before moving forward with the transaction or process. In order to ensure impartiality, a party trying to verify such information usually turns to a third party such as a titling company or credit reporting agency. If all information is corroborated, the value of a home, business, asset, or salary typically increases because the buyer or employer has confidence in the integrity and transparency of all aspects of the transaction.

Despite the many forms of third party verification that may take place in other business transactions, no such process takes place in the industry comprising debt sales, purchases, and/or transfers. Instead, participants in this industry rely on trust and hope to verify precisely what it is the participant is buying. This reliance on trust and hope has led to billions of dollars being paid annually for accounts that may have already been sold to another Issuer or Debt Buyer, are the subject of a validated dispute, identity theft, bankruptcy, or simply cannot be collected because the debtor is deceased with no estate.

Therefore, there exists a long felt need for a system that provides increased certainty to the process of selling, transferring, or purchasing debt portfolios by providing chain of title verifications for debt accounts.

### SUMMARY OF THE PRESENT DISCLOSURE

The present disclosure meets the foregoing need and provides a system that provides increased certainty to the process of selling, transferring, or purchasing debt portfolios by providing chain of title verifications for debt accounts.

In accordance with one aspect of the disclosure a method for establishing chain of title for a debt portfolio is disclosed. The method may include receiving an initial registration request to register a debt portfolio. The debt portfolio may be associated with one or more records. One or more of the records may be stored in a data structure. The method may also include updating an account history associated with the initial registration request and generating an initial report including one or more of the records associated with a debt portfolio.

Additional aspects of the disclosure may include a method that comprises assigning of a unique portfolio certification number to a debt portfolio and assigning a unique registered account identifier to each account. The method may also include receiving a request to transfer ownership of a debt portfolio, authenticating the identity of each participant to the debt portfolio transfer, and determining that a debt portfolio is cleared for transfer. To ensure data integrity, one aspect of the disclosure contemplates performing data verification in order to verify that the debt portfolio that is requested for transfer is valid. In addition to the foregoing features, the method may also include updating an account history in accordance with the transfer of ownership.

In accordance with another aspect of the disclosure, a data structure stored on a computer readable medium is disclosed. The data structure may store data in a computer readable medium and, alternatively or in addition, the data structure may function as a data source that may be used to generate a report. Such a disclosed data structure may include attributes associated with a debt portfolio and information conveying a chain of ownership summary for a debt portfolio.

In accordance with another aspect of the disclosure a debt registry system is disclosed. The debt registry system may include a registration module configured to receive a request to register a debt portfolio, a transferring module configured to receive a request to transfer a debt portfolio from a first owner to a second owner, and a generating module configured to generate a virtual title report.

Additional aspects of the disclosure may include a debt registry system comprising a first assigning module and second assigning module each configured to assign a unique portfolio certification number to a each debt portfolio and a unique registered account identifier to each account, respectively. The debt registry system may also include an associating module configured to associate a debt portfolio with an account, in addition, the debt registry system may include an authenticating module configured to authenticate the identity of each participant to the debt portfolio transfer and a data verification module configured to verify that the debt portfolio that is requested for transfer is valid. Furthermore, the debt registry system may include an updating module configured to update an account history in the event of a transfer of ownership for a debt portfolio and an accessing module to provide access to one or more debt portfolio bidding services.

Additional aspects of the disclosure may include wherein the generating module may also be configured to generate one or more of an initial registration report, a transfer of ownership registration report, and an account history report. Also, the debt registry system may include a clearing module configured to determine that a debt portfolio is cleared for transfer.

Additional features, advantages, and aspects of the present disclosure may be set forth or apparent from consideration of the following detailed description, drawings, and claims. Moreover, it is to be understood that both the foregoing summary of the present disclosure and the following detailed description are exemplary and intended to provide further explanation without limited the scope of the present disclosure as claimed,

### BRIEF DESCRIPTION OF THE DRAWINGS

The accompanying drawings, which are included to provide a further understanding of the present disclosure, are incorporated in and constitute a part of this specification, illustrate aspects of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1 shows an example of a computer system, in accordance with one aspect of the disclosure;

FIG. 2 shows an example of a server storing computer program modules, which when executed, may facilitate chain of title verification for debt portfolios, in accordance with one aspect of the present disclosure;

FIG. 3 shows an example of a process for providing chain of title verification for debt portfolios, in accordance with one aspect of the present disclosure;

FIG. 4 shows an example of a process that a facilitate the initial registration of a debt portfolio, in accordance with one aspect of the present disclosure;

FIG. 5 shows an example of an initial registration report, in accordance with one aspect of the present disclosure;

FIG. 6 shows an example of a process that may facilitate data verification, in accordance with one aspect of the present disclosure;

FIG. 7 shows an example of a process that may facilitate the transfer of a debt portfolio from a first user to a second user, in accordance with one aspect of the present disclosure;

FIG. 8 shows an example of a transfer of ownership registration report, in accordance with one aspect of the present disclosure;

FIG. 9 shows another example of a transfer of ownership registration report, in accordance with one aspect of the present disclosure;

FIG. 10 shows an example of an account history report, in accordance with one aspect of the present disclosure.

### DETAILED DESCRIPTION OF THE PRESENT DISCLOSURE

The aspects of the present disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the present disclosure. The examples used herein are intended merely to facilitate an understanding of ways in which the present disclosure may be practiced and to further enable those of skill in the art to practice the aspects of the present disclosure. Accordingly, the examples and aspects herein should not be construed as limiting the scope of the present disclosure, which is defined solely by the appended claims and applicable law. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a tablet computer, a mobile telephone, a smart phone, a personal data assistant (PDA), a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation,

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections o service requests from clients by sending back responses to the clients. The database may be configured to run the at least one application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like,

A “network,” as used in this disclosure means, but is not limited to, for example, at least one of a local area e work (LAN), a wide area network (WAN), storage area network (SAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium.

A “user”, as used in this disclosure, means any person that attempts to avail the services provided by the debt registry system as disclosed herein. Such a user may avail the debt registry system using a computer. Alternatively, such a user may avail the debt registry system in a conversation that takes place over the phone, or in a personal face-to-face meeting, with a representative, employee, agent, or independent contractor of an organization that provides debt registry services. Such a user may be an issuer, a Buyer of Debt, or other debt owner.

A “computer-readable medium” or “computer-readable media”, as used in this disclosure, means any medium/media that participates in providing data (for example, instructions) which may be read by a computer. Such a medium/media may take many forms, including non-volatile media., volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read,

Various forms of computer readable media may be involved in carrying sequences of instructions to a computer. For example, sequences of instruction (i) may he delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards. Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

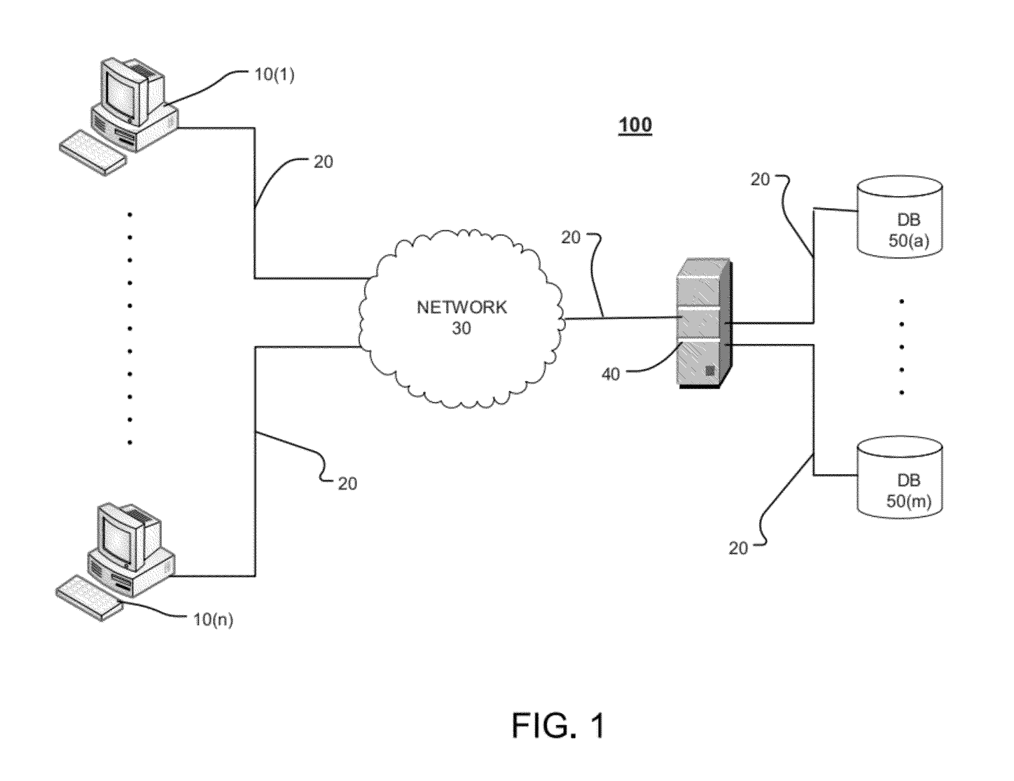

FIG. 1 shows an example of a computer system 100 that may be used to provide account chain of title verification for debt portfolios, in accordance with one aspect of the disclosure. Computer system 100 may include one or more client computers (or user devices) 10(1) to 10(n) (where n is a positive integer that is greater than 1), a network 30, a server (or computer) 40, and/or one or more databases 50(a) to 50(m) (wherein m is a positive integer that is greater than 1). The server 40 and one or more database(s) 50(a) to 50(m) may be connected to each other and/or the network 30 through one or more communication links 20. The client computers (or user devices) 10(1) to 10(n) may each be coupled to the network 30 via the communication links 20. A user may operate one or more of client computers 10(1) to 10(n) in order to avail the services of the disclosed debt registry system. Alternatively, for example, a representative, employee, agent, or independent contractor of an organization providing debt registry services may operate one or more of client computers (or user devices) 10(1) to 10(n) in order to avail the services of the debt registry system on behalf of a user that has communicated with the representative, employee, agent, or independent contractor for the purpose of availing the services provided by the debt registry system.

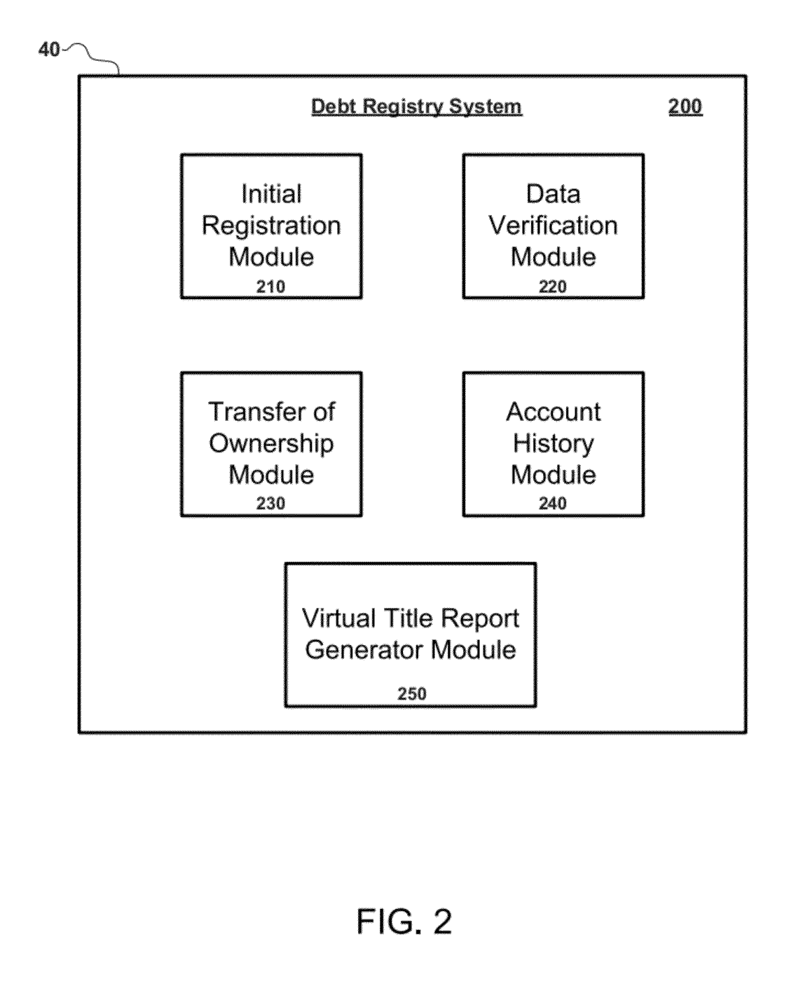

FIG. 2 shows an example of a debt registry system 200 that may reside on server 40. As depicted, server 40 may include one or more computer program modules 210, 220, 230, 240, and 250 that may, when executed, facilitate account chain of title verification for debt portfolios, in accordance with one aspect of the present disclosure. For example, server 40 may include computer program modules to facilitate initial registration of a debt portfolio 210, data verification 220, transfer of ownership for a debt portfolio 230, account history 240, and generation of a virtual title report 250. The process that may take place when each of these modules is executed is disclosed hereinbelow.

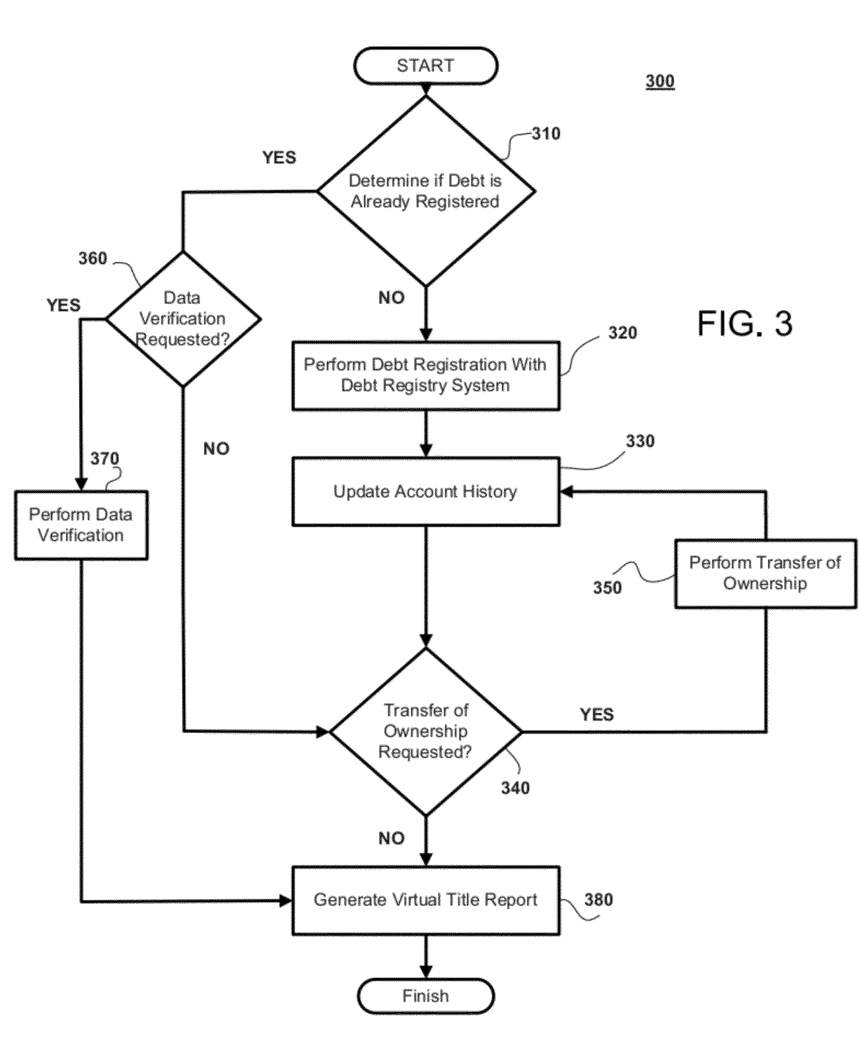

FIG. 3 shows an example of a process 300 for providing account chain of title verification for debt portfolios, in accordance with one aspect of the present disclosure. Process 300 may be initiated in a plurality of ways. For example, a client 10 may visit a website that facilitates access to debt registry system 200 that executes computer modules stored on a server 40 as depicted in FIG. 2. Alternatively, for example an over the counter software, or downloadable application, including software modules 210, 220, 230, 240, and 250 may reside on client 10 which gathers information input by a user in one or more computer generated forms, or other application windows and/or data structures, and then transmits gathered information via network 30 to remote server 40 and/or database 50. Additionally, the process in FIG. 3 may be initiated in a phone call, or personal face-to-face meeting, with a representative, employee, agent, or independent contractor of an organization that provides debt registry services in order to facilitate chain of title verification for a debt portfolio as disclosed herein. However, one of ordinary skill in the art would appreciate that the disclosure need not be limited to such examples. Therefore, while the disclosure will be described hereinbelow with respect to debt registry system 200 residing on server 40, it will be readily apparent to one of ordinary skill in the art that any means for carrying out process 300 will fall within the spirit and scope of the disclosure.

As depicted in FIG. 3, step 310 may determine if a debt portfolio has already been registered with debt registry system 200. Such a determination may take place in a variety of ways. A user may be presented with a prompt via a graphical user that permits the user to indicate whether a debt has been previously registered. This may occur, e.g., by providing a choice of radio buttons, drop-down menus, or other graphical selection object(s)/indicator(s). Alternatively, a user may enter an identifier for a debt portfolio, e.g., a portfolio certification number, account number, etc., and perform a search of database 50 in order to determine if a debt as been registered. Additionally, a user may discuss with a representative, employee, agent, or independent contractor of an organization that provides debt registry services in a telephone call, or in a personal face-to-face meeting, whether or not a debt has been registered. It is noted, hereinafter, that each of the process steps, or other operations, disclosed herein may be carried out in a manner that is similar to one or more of the preceding examples.

Process 300 may follow a plurality of execution paths. For example, at least two execution paths may be determined based upon whether or not a debt portfolio has been registered with debt registry system 200. If a debt portfolio has not already been registered, the process may proceed to step 320 in order to perform initial debt registration with debt registry system 200. After a debt is registered in step 320, the debt registry system 200 may update the account history in step 330 to reflect the transaction that is taking place with the account, e.g., an initial registration. Then, at step 340 the process may determine if a transfer of ownership is being requested. If a transfer of ownership is requested at step 340, the debt registry system may perform transfer of ownership at step 350. Then the process may loop back to step 330 in order to update the account history 330 to reflect the transaction that is taking place with the account, e.g., a transfer, sale, purchase, etc., and determine if another transfer of ownership is being requested 340. If the debt registry system 200 determines that another transfer of ownership is not being requested at step 340, then debt registry system 200 may generate a virtual title report in step 380. However, it should be noted that process 300 is merely an example of a debt registration process that may be performed by debt registry system 200. It will be readily apparent to one of ordinary skill in the art that other variations of process 300 may fall within the spirit and scope of the disclosure. For example, a virtual title report may not necessarily need to be generated each and every time a new debt portfolio is registered with debt registry system 300. Similarly, a virtual title report may be generated at times when a new debt portfolio is not being registered. Therefore, a variety of different collections and/or combinations of one or more steps set forth in process 300 may fall within the spirit and scope of the disclosure. Additionally, it should be contemplated that one or more steps of process 300 may be duplicated and/or excluded.

According to another execution path, process 300 may, for example, determine at step 310 that the debt portfolio has already been registered. If a user's requested debt portfolio has already been registered, the debt registry system 200 may determine if data verification is to be performed 360. If data verification is to be performed, debt registry system performs data verification at step 370. After data verification is performed at step 370, a user may request that a virtual title report is generated at step 380. Alternatively, if data verification is not to be performed at step 360, the user may be prompted to determine if a transfer of ownership for an already registered debt portfolio is requested. If determined that a transfer of ownership is to be performed, steps 350 and 330 may be executed. Finally, when it is determined at 340 that either no transfer of ownership requests exists, or all transfers of ownership have been completed, the process moves on to step 380 where a virtual title report may be generated.

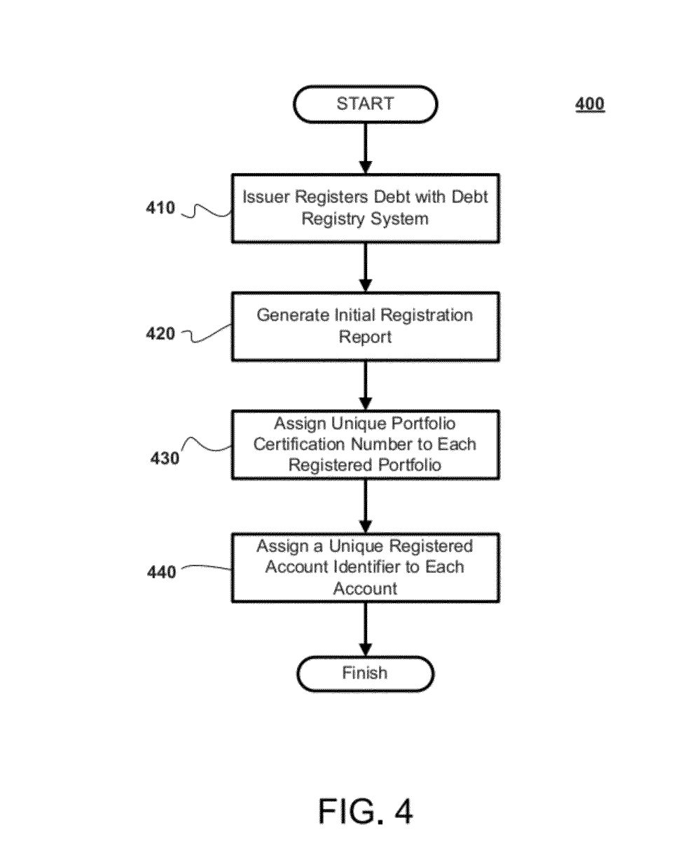

The initial debt registration that may take place in FIG. 3, step 320 may be performed in accordance with process 400 set forth in FIG. 4. Process 400 may be performed by, e.g., initial registration module 210. Process 400 begins at step 410 when a user registers, e.g., a portfolio of charged off debt, with debt registry system 200 by providing electronic records of each such portfolio into a secure database 50 maintained by debt registry system 200. Step 410 may include, e.g., a user submitting a request for registration that is received by debt management system 200. After the user's request is received by debt registry system 200, a data structure may be generated to store and/or maintain one or more records associated with the debt portfolio. Alternatively, a data structure may be used to store and/or maintain one or more records associated with the debt portfolio that was generated, or already existing, at some point in time prior to the user's request. The data structure may reside in debt registry system 200 and/or computer system 100. Step 410 may be performed, e.g., by a user on or around the time a charge-off of debt occurs. Alternatively, e.g., step 410 may be performed when a portfolio is being prepped for sale by an Issuer to another Issuer or Debt Buyer. Each debt portfolio, and associated records, is then associated by debt registry system 200 with a debt account. The records associated with a debt portfolio may include any data attributes that may be associated with a debt portfolio account, e.g., account number, account balance, original issuer, account open data, delinquency date, charge-off date, original charge-off balance, debtor name, debtor social security number, etc. In addition, the records associated with a debt portfolio may include various media associated with the account including, e.g., statements, the card holder agreement(s), the original application by the cardholder, affidavits by Issuer staff attesting to the validity and accuracy of the account information, and any other information that may have been maintained and is related to the account, or the account's status. All such records, whether data attributes or media, may be stored and/or maintained in a variety of formats, e.g., in PDF format, TIFF format, DOC format, etc. The records, whether data attributes or media, may be transmitted, communicated, transferred, pushed, and/or pulled between one or more computers in manner that maintains security of the data white it is being transmitted, communicated, transferred, pushed, and/or pulled between one or more computers. Data security may be maintained with respect to all stored debt accounts, debt portfolios, and/or records/media using a variety of encryption standards and data transfer techniques known in the art. Specifically, at least one aspect of the present disclosure utilizes, PCI Data Exchange and/or the PCI DSS standard, in order to maintain data security with respect to the transmitted, communicated, transferred, pushed, and/or pulled records/media.

At step 420, debt registry system 200 generates an Initial Registration Report that records key account level data attributes that may be used, e.g., in order to validate debt transfers, sales, or purchases that may occur involving a particular portfolio, or, e.g., in requests for data verification by a current debt portfolio owner. Each of these attributes may be maintained, e.g., in a data structure stored in data registry system 200. The fields in Initial Registration Report may be populated with data stored and/or maintained in a data structure stored in the debt registry system 200. Next, in step 430, a unique Portfolio Certification Number is assigned to each registered portfolio by debt registry system 200. Finally, in step 440 a Registered Account Identifier is assigned to each account and is associated with the account for the remainder of the time the account is maintained by debt registry system 200. The Portfolio Certification Numbers and Registered Account Identifiers may be used to identify debt portfolios and debt accounts, respectively. Accordingly, one or more debt portfolios, via the Portfolio Certification Number, may be associated with one or more debt accounts or Registered Account Identifiers.

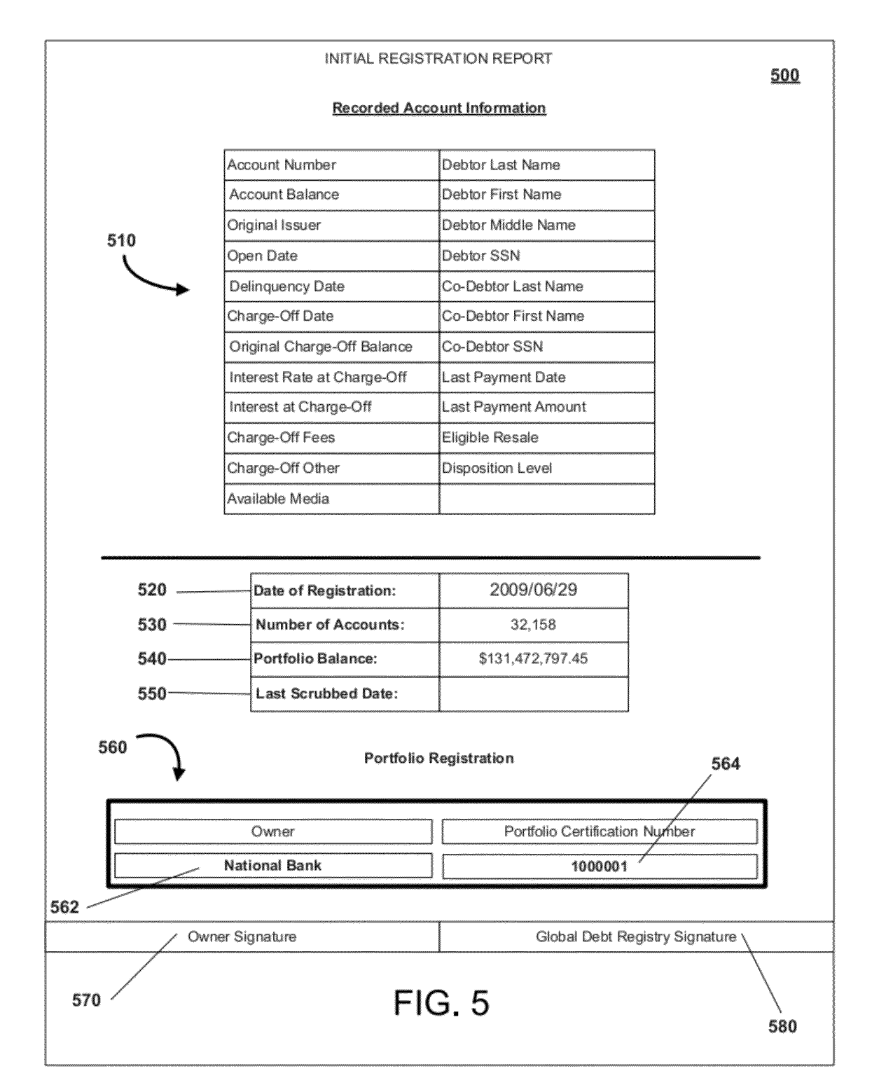

FIG. 5 illustrates an example of an Initial Registration Report 500, in accordance with one aspect of the present disclosure. Initial Registration Report 500 may include attributes 510 which may be used to validate, e.g., debt transfers and other portfolio/account transactions and/or identify a particular account. In addition, Initial Registration Report 500 may include the date of portfolio registration 520, number of accounts 530, portfolio balance 540, and a date that the data was last scrubbed (e.g., verified, validated, etc.) 550. In addition, an Initial Registration Report 500 may include Portfolio Registration information 560 including the name of the debt portfolio owner 562 and the Portfolio Certification Number 564. Initial Registration Report 500 may also comprise one or more fields wherein the portfolio registration may be acknowledged with a signature by the owner of the portfolio 570 and a signature by a representative, employee, agent, or independent contractor of an organization 580 providing debt registry service. At least one aspect of the disclosure provides that the signatures provided in fields 562 and 564 may be, e.g., digital signatures in accordance with the E-SIGN Act. Additionally, all information included in the Initial Registration Report 500, all information associated with a particular debt portfolio/account, and/or all information provided to debt registry system 200 may be stored in one or more data structures which are stored in one or more computer readable media within computer system 100 residing in, e.g., the client 10, sever 40, database 50, etc. It is noted that all data residing within, or being displayed by, the Initial Registration Report may be populated from records stored in the one or more data structures residing within debt registry system 200 and/or computer system 100.

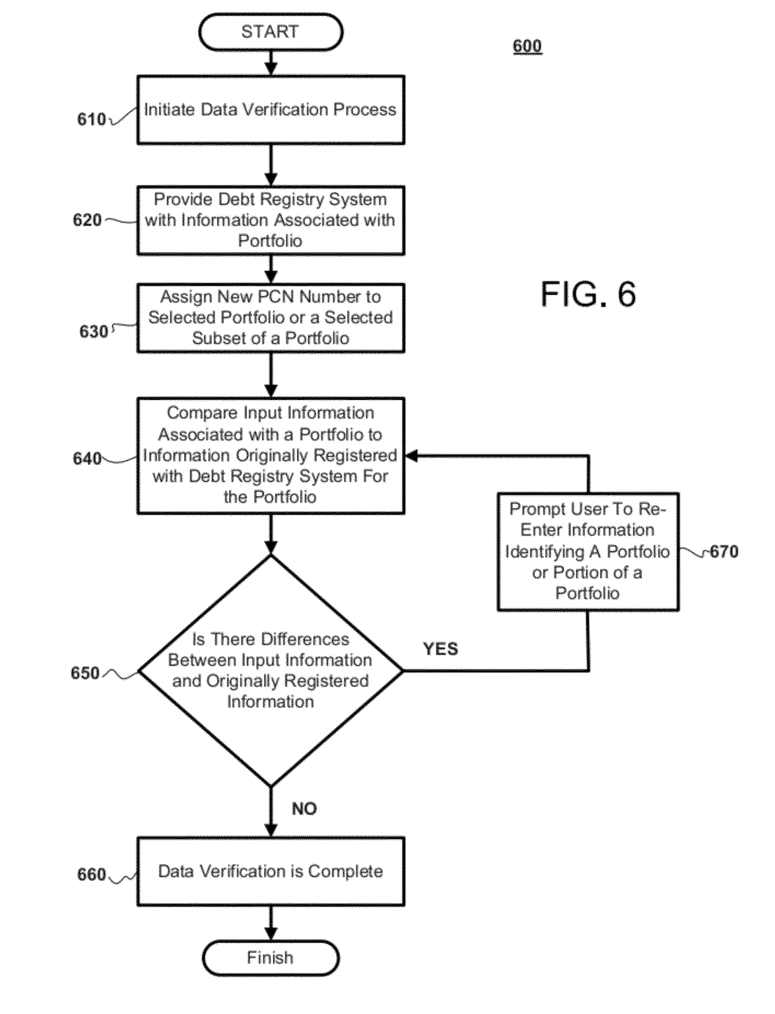

Data verification that may take place in FIG. 3, step 370 may be performed in accordance with process 600 set forth in FIG. 6. Process 600 may be performed by, e.g., data verification module 220. Process 600 begins in step 610 when a user that has registered a debt portfolio, or has already purchased a debt portfolio, via debt registry system 200 wishes to sell all or part of the debt portfolio. Before the sale or transfer takes place, a user may provide debt registry system 200 with information associated with portfolio as set forth in step 620 and such information may include, e.g., originating issuer, original account number, account holder's name, account holder's social security number, charge-off date, last paid date, or other information maintained for an account as shown in FIG. 5, 510 in order to perform data verification. Then, in step 630 the debt registry system 200 assign a new Portfolio Certification Number to the portfolio, or portion of the portfolio, selected for sale or transfer.

Process 600 continues in step 640 by comparing the seller's input information associated with the portfolio, or a portion of the portfolio, to the originally registered portfolio data. Step 650 determines if there are differences between the input information entered by the seller and the originally registered information. If there is no difference between the sets of data, then the data is determined to be verified and the process is completed in step 660. However, if differences exist between the input information entered by the user and the originally registered information, debt registry system 200 provides an exception and then prompts the user to re-enter information associated with the portfolio, or portion of the portfolio, at step 670. At this point process 600 iteratively continues until all exceptions are resolved by debt registry system 200. When all exceptions are resolved, the process will complete at step 670 and the portfolio is cleared for sale, transfer, or purchase. Therefore, FIG. 6, elements 640, 650, and 670 provide a logic loop that facilitates clearing, verifying, or validating a debt portfolio for sale, transfer, or purchase. Note, that although a Portfolio Certification Number may change, the Registered Account Identifier for each account does not change, thereby facilitating the tracking of a complete account history for any given account.

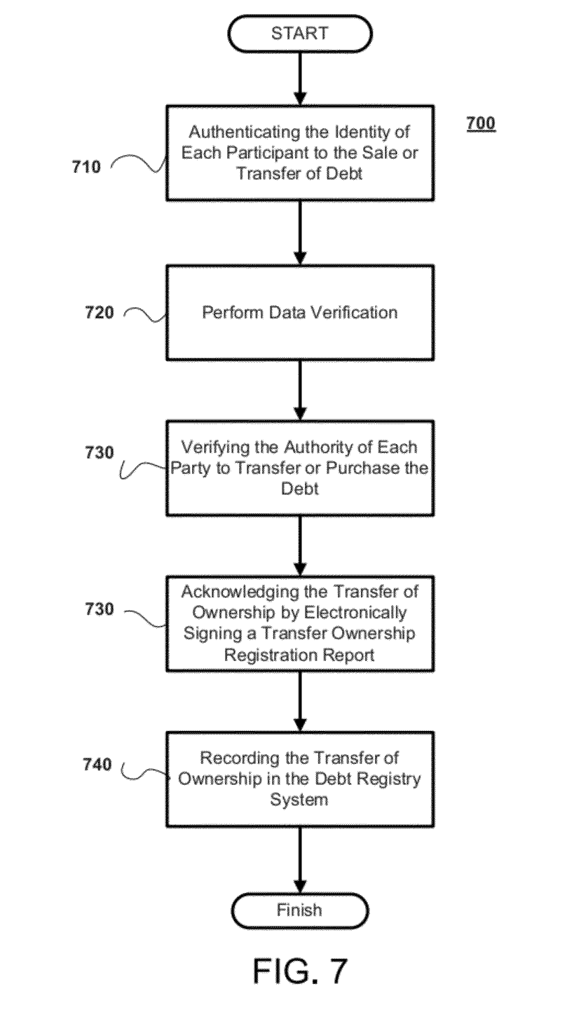

The transfer of ownership that may take place in FIG. 3, step 350 may be performed in accordance with process 700 set forth in FIG. 7. Process 700 may be performed by, e.g., transfer of ownership module 230. After a request for a sale or transfer of one or more selected debt portfolios is received by debt registry system 200, debt registry system 200 performs step 710 and authenticates the identity of the user. At step 720, debt registry performs data verification in order to increase the level of certainty confirming that the debt portfolio requested for sale, transfer, or purchase is valid. A valid debt portfolio may have an identified owner, e.g., updated chain of title, and may sufficiently satisfy the sale, transfer, or purchase request. Such data verification helps debt management system 200 to facilitate a high level of data integrity. Step 720 may execute a data verification procedure as set forth in FIG. 6, or other data verification procedures known in the art.

At step 730, debt registry system 200 verifies that each user involved in the transaction has the authority to sell, transfer, or purchase all, or at least a portion of, a portfolio. Step 740 further requires that the user acknowledge the transfer of ownership by signing a Transfer of Ownership Registration Report. The signature may be, e.g., a digital signature in accordance with the E-SIGN Act. Finally, at step 750 process 700 records the transfer of ownership of a selected portfolio. Therefore, each total, or partial, transfer of a portfolio, is recorded in the debt management system's 200 electronic records.

At least one aspect of the present disclosure may include implementing transfer of ownership process 700 in association with an affiliated debt portfolio/account bidding service, platform, or application (not shown in Figures). Such a debt portfolio/account bidding service, platform, or application may comprise one or more computer program modules residing on a server or other computer, e.g., client 10 or server 40, and may be connected to debt registry system 200 by one or more communication link(s) 20 and/or through one or more network(s) 30. Therefore, a user choosing to avail the services of debt registry system 200 may be provided with the option of accessing one or more debt portfolio/account bidding service(s).

The debt portfolio/account bidding service may facilitate bidding on debt portfolios/accounts in an auction-like format. Such a debt portfolio/account bidding service may be provided by, e.g., Global Debt Exchange. However, it will be readily apparent to one of ordinary skill in the art that the disclosure need not be so limited. Instead, such a debt portfolio/account bidding service may comprise any service, platform or application that provides users the ability to post debt portfolios/accounts for sale, accept bids for debt portfolios, process a sale or transfer of a debt portfolio/account, provide a secure location for review of portfolios, track which buyers access a portfolio, and/or facilitate the distribution of supporting materials (e.g., seller survey, contracts, etc.).

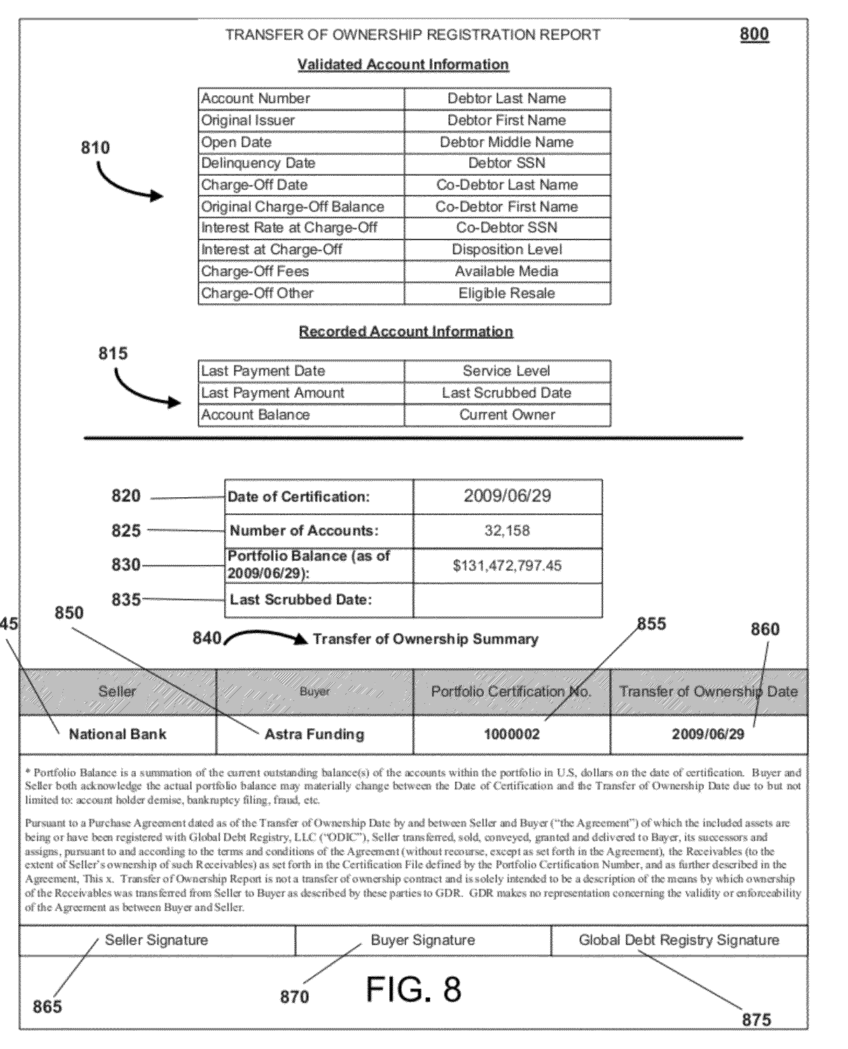

FIG. 8 illustrates an example of a Transfer of Ownership Registration Report 800, in accordance with one aspect of the present disclosure. Transfer of Ownership Registration Report 800 may also include Validated Account Information 810 that may be used to validate an account in order to maintain data integrity. In addition, the Transfer of Ownership Report 800 may include Recorded Account Information 815 detailing certain attributes associated with the account that includes the particular debt portfolio which is the subject of the transfer. Transfer of Ownership Report 800 may include the date of portfolio certification 820, number of accounts 825, portfolio balance 830, and a date that the data was last scrubbed (e.g., verified, validated, etc.) 835. The Transfer of Ownership Registration Report may also provide a Transfer of Ownership Summary 840 including the name of the seller 845, name of the buyer 850, portfolio certification number 855, and transfer of ownership date 860. Transfer of Ownership Registration Report 800 may also comprise one or more fields wherein the portfolio transfer may be acknowledged via a signature by the seller of the portfolio 865, a signature by the buyer of the portfolio 870, and/or a signature by a representative, employee, agent, or independent contractor of an organization 875 providing debt registry service. At least one aspect of the disclosure provides that the signatures provided in fields 865, 870, and 875 may be, e.g., digital signatures in accordance with the E-SIGN Act. Additionally, all information included in the Transfer of Ownership Report 800, all information associated with a particular debt portfolio/account, and/or all information provided to debt registry system 200 may be stored in one or more data structures which are stored in one or more computer readable medium within computer system 100 residing in, e.g., the client 10, sever 40, database 50, etc. Finally, it should be contemplated that all data residing within, or being displayed by, the Transfer of Ownership Report may be populated from records stored in the one or more data structures residing within debt registry system 200 and/or computer system 100.

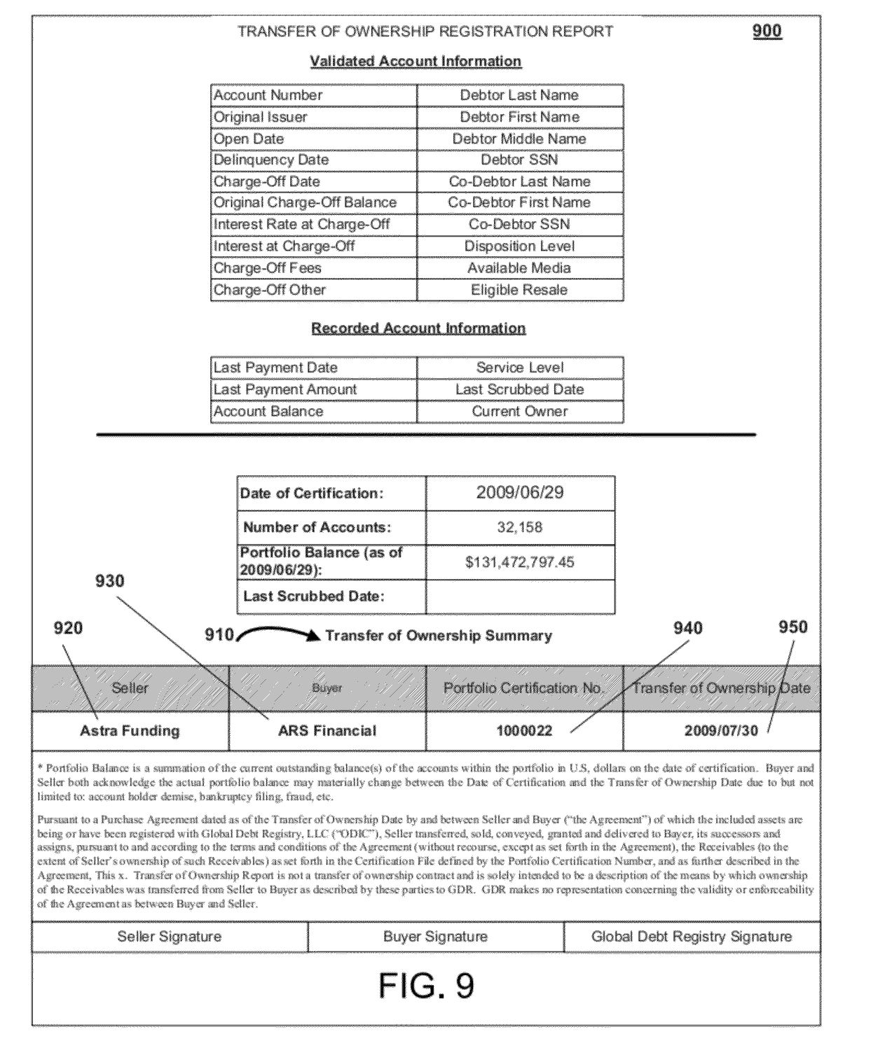

FIG. 9 illustrates another example of a Transfer of Ownership Registration Report 900, in accordance with one aspect of the present disclosure. Transfer of Ownership Registration Report 900 comprises substantially the same features as Transfer of Ownership Registration Report 800. However, Transfer of Ownership Registration Report 900 records a subsequent transfer of the same debt portfolio whose transfer was recorded in Transfer of Ownership Registration Report 800. For example, FIG. 8, elements 845, 850 indicate that a debt portfolio transferred from National bank (e.g., seller) 845 to Astra Funding (e.g., buyer) 850. Then, for example, FIG. 9 shows a Transfer of Ownership Summary showing that the same debt portfolio has now transferred from Astra Funding (e.g., seller) 920 to ARS Financial 930 (e.g., buyer). Similarly, each transfer of a debt portfolio may be recorded using a Transfer of Ownership Registration Report similar to the Transfer of Ownership Registration Reports seen in FIG. 8 and FIG. 9.

As seen in FIG. 3, step 330 the debt registry system 200 may maintain an account history for each registered account, in accordance with at least one aspect of the present disclosure. Account history may be maintained by, e.g., account history module 240. Such an account history may include the previously registered account data provided by the Issuer and Subsequent Debt Owner(s). This account history may be used to generate an Account History Report that includes a Chain of Ownership Summary beginning with the initial registration of a debt portfolio and the including the details of each successive transfer of ownership for the registered debt portfolio. This Account History Report therefore represents an electronic business record including both portfolio level business records and account level business records which are maintained and managed by debt registry system 200.

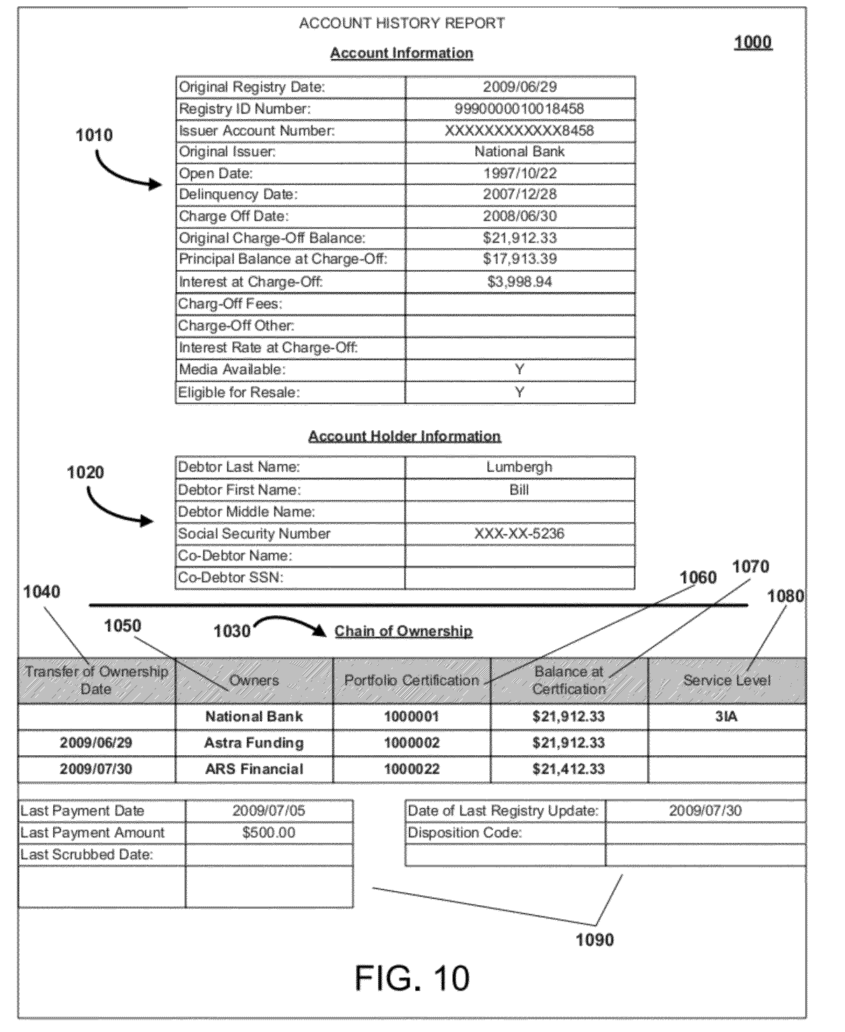

FIG. 10 illustrates an example of an Account History Report 1000, in accordance with one aspect of the present disclosure. Account History Report 1000 may include information 1010 related to the account for which each debt portfolio is associated with 1010. Account History Report 1000 may also include information 1020 identifying an account holder. In addition, Account History Report 1000, may also include a Chain of Ownership Summary 1030, Chain of Ownership Summary may include relevant information that is sufficient to convey chain of ownership, or chain of title, for a debt portfolio. Additionally, all information included in the Account History Report 1000, all information associated with a particular debt portfolio/account, and/or all information provided to debt registry system 200 may be stored in one or more data structures which are stored in one or more computer readable medium within computer system 100 residing in, e.g., the client 10, sever 40, database 50, etc. Finally, it should be contemplated that all data residing within, or being displayed by, the Account History Report may be populated from records stored in the one or more data structures residing within debt registry system 200 and/or computer system 100.

Chain of Ownership Summary 1030 provides a complete history of a debt portfolio from the time the debt portfolio is initially registered. In FIG. 3, step 320 to the time Account History Report 1000 is generated. The Chain of Ownership Summary may include attributes such as the transfer of ownership date 1040, the owner of the debt 1050, the portfolio certification number 1060, the balance at certification 1070, service level 1080, and other miscellaneous information 1090 which may be helpful to facilitate determining proper chain of ownership. Such a Chain of Ownership Summary may provide a user with increased certainty when participating in a sale, transfer, or purchase of one or more debt portfolios. This is particularly important for a purchaser of debt because it may serve to reassure the buyer that the person or entity selling the debt portfolio actually owns the debt portfolio. Therefore, the value of the debt portfolio may actually increase, since its ownership has been verified.

The final step of process 300 may include the generation of a Virtual Title Report in step 380. The Virtual Title Report that may be generated at step 380 may be generated by, e.g., virtual title report generator module 250. From initial registration in FIG. 3, step 320, through all interim sales or other transfers of ownership, and up to the most recent sale or transfer, all transactions are clearly recorded and reflected in a manner that debt buyers can use to prove ownership of one or more debt portfolios, thereby providing a method for perfecting ownership in a managed debt account. The Virtual Title Report displays the chain of title by combining on one or more aspects of the Initial Registration Report 500, Transfer of Ownership Registration Report 800, and Account History Report 1000. This may occur in a one or more of a variety of ways. For example, a Virtual Title Report may be generated by simply furnishing a copy of the Initial Registration Report 500, a copy of one or more Transfer of Ownership Registration Reports 800, and Account History Report 1000. In addition, a Virtual Title Report may be generated, e.g., by selecting relevant and/or specific features from one or more of the generated reports (i.e., Initial Registration Report, Transfer of Ownership Report, and Account History Report), and combining the features into a single report that is sufficient to display chain of title of a debt portfolio associated with a debt account. However, it will be readily apparent to one of ordinary skill in the art that the present disclosure need not be so limited to the specific examples set forth herein. Therefore, it should be considered that any combination of records stored by debt registry system 200 may be combined and presented in order to sufficiently convey chain of title with respect to a debt portfolio may reasonably be interpreted as falling within the spirit and scope of a Virtual Title Report as set forth herein.

Although debt sellers and buyers have proceeded without a process for verifying chain of ownership with respect to debt portfolios in the past, such verification is increasingly being required by courts, legislatures, and others. This is particularly relevant with respect to litigation proceedings. As a result, it is contemplated that the reports generated by debt registry system 200 may be used in court to prove chain of ownership, or chain of title, at the account level with respect to a particular debt portfolio. Such reports may be admissible because debt registry system 200 may manage records, media, and reports in accordance with the business records exception to hearsay rule under the Federal Rules of Evidence (e.g., FRE 803(6)). Debt registry system 200 may satisfy this Rule because the Initial Registration Report may be generated at the time of initial registration of an account(s), the Transfer of Ownership Registration Report may be generated at the time of transfer of the account(s), and the Account History Report may be generated from debt registry system's 200 electronic records made at the time of registration or the last relevant transfer. In addition, the records may be made by, or under the supervision, of persons, e.g., a database or systems administrator, with knowledge of the registration or transfer and in the course of debt registry system's 200 regularly conducted business activity. Furthermore, as a normal part of its business practice, debt registry system 200 may provide affidavits to users which establish a chain of title by demonstrating the registration and transfer history of a debt account which may include one or more debt portfolios associated with the cause of action being brought against a person in a lawsuit. Such affidavits may be prepared for the purpose of meeting the certification requirements of FRE 902(11).

Therefore, it is clear that the chain of title verification that is provided by debt registry system 200 provides a variety of proven benefits for a variety of different participants. These benefits range from providing increased certainty to a party involved in a debt purchasing transaction to providing a means for introducing a chain of ownership of a debt portfolio which may qualify for admission in a court proceeding. Such benefits clearly provide a novel and nonobvious improvement of the prior art.

While the present disclosure has been described in terms of exemplary aspects, those skilled in the art will recognize that the present disclosure can be practiced with modifications in the spirit and scope of the appended claims. These examples given above are merely illustrative and are not meant to be an exhaustive list of all possible designs, aspects, applications or modifications of the present disclosure.

What is claimed is:

1. A method for establishing chain of title for a debt portfolio, comprising:
receiving an initial registration request to register a debt portfolio, wherein the debt portfolio is associated with one or more records;
storing the one or more associated records in a data structure;
updating an account history associated with the initial registration request; and,
generating an initial registration report including one or more of the records associated with a debt portfolio,

2. The method of claim 1, further comprising assigning a unique portfolio certification number to a debt portfolio.

3. The method of claim 1, further comprising assigning a unique registered account identifier to each account.

4. The method of claim 3, further comprising associating a debt portfolio with an account.

5. The method of claim 1, further comprising:
receiving a request to transfer ownership of a debt portfolio;
performing data verification in order to verify that the debt portfolio requested for transfer is valid.

6. The method of claim 1, further comprising:
receiving a request to transfer ownership of a debt portfolio;
authenticating the identity of each participant to the debt portfolio transfer; and,
determining that a debt portfolio is cleared for transfer.

7. The method of claim 6, further comprising:
updating an account history in accordance with the transfer of ownership.

8. A data structure stored on a computer readable medium, the data structure comprising:
attributes associated with a debt portfolio; and,
information conveying a chain of ownership summary for a debt portfolio.

9. A debt registry system, comprising:
a registration module configured to receive a request to register a debt portfolio;
a transferring module configured to receive a request to transfer a debt portfolio from a first user to a second user; and,
a generating module configured to generate a virtual title report.

10. The system of claim 9, further comprising a first assigning module configured to assign a unique portfolio certification number to a debt portfolio.

11. The system of claim 10, further comprising a second assigning module configured to assign a unique registered account identifier to each account.

12. The system of claim 11, further comprising an associating module configured to associate a debt portfolio with an account.

13. The system of claim 9, further comprising:
an authenticating module configured to authenticate the identity of each participant to the debt portfolio transfer.

14. The system of claim 9, further comprising:
a data verification module configured to verify that the debt portfolio requested for transfer is valid.

15. The system of claim 9, further comprising:
an updating module configured to update an account history in the event of a transfer of ownership for a debt portfolio.

16. The system of claim 9, further comprising:
an accessing module to provide access to one or more debt portfolio bidding services.

17. The system of claim 9, wherein the generating module may be further configured to generate an initial registration report.

18. The system of claim 9, wherein the generating module may be further configured to generate a transfer of ownership registration report.

19. The system of claim 9, wherein the generating module may be further configured to generate an account history report.

20. The system of claim 9, further comprising:
a clearing module configured to determine that a debt portfolio is cleared for transfer.
